(19) United States
(12) Patent Application Publication
(10) Pub. No.: US 2014/0140662 A1
(43) Pub. Date: May 22, 2014

(54) FIBER OPTIC CABLE ASSEMBLIES HAVING A CONNECTOR WITH A STABLE FIBER LENGTH THEREIN

(71) Applicant: Corning Optical Communications LLC, Hickory, NC (US)

(72) Inventors: Alvin John McDonald, Rutherford College, NC (US); Sherrh Clint Reinhardt, Hickory, NC (US); Hieu Vinh Tran, Charlotte, NC (US); Thomas Theuerkorn, Hickory, NC (US)

(73) Assignee: Corning Optical Communications LLC, Hickory, NC (US)

(21) Appl. No.: 14/161,187

(22) Filed: Jan. 22, 2014

Related U.S. Application Data
(63) Continuation of application No. PCT/US12/47915, filed on Jul. 24, 2012.
(60) Provisional application No. 61/513,257, filed on Jul. 29, 2011.

(51) Int. Cl. G02B 6/44

(52) U.S. Cl. CPC G02B 6/4429; G02B 6/4483
USPC 385/76; 29/428

(57) ABSTRACT

Cable assemblies having a connector with a stable fiber length within the connector and methods for making the same are disclosed. In one embodiment, a filling material is disposed in the passageway of a fiber optic cable near a first end where the connector is attached for inhibiting the optical fiber from movement adjacent to the first end of the cable. The filling material may be placed into fiber optic cable using any suitable method such as injecting into the end of the cable or forming a window in the cable and inserting the filling material into the window.

### RELATED APPLICATIONS

This application is a continuation of International Application No. PCT/US12/47915 filed Jul. 24, 2012, which claims the benefit of priority to U.S. Application No. 61/513,257, filed Jul. 29, 2011, both applications being incorporated herein by reference.

### BACKGROUND

The disclosure is directed to cable assemblies having at least one fiber optic connector. More specifically, the disclosure is directed to cable assemblies having a connector with a filling material disposed in the cable passageway near the end of the cable for creating a stable fiber length within the connector and methods for making the same.

Optical fiber is increasingly being used for a variety of applications, including but not limited to broadband voice, video, and data transmission. As bandwidth demands increase the optical fibers are being deployed in more outdoor communication networks. The outdoor networks are much more demanding environments than the indoor environments. For instance, outdoor applications must withstand a wide range of temperature, humidity and installation practices not typically encountered with indoor networks. Consequently, manufacturers are required to make more robust assemblies that can withstand the rigors of these outdoor networks.

Early outdoor networks typically relied on fusion splicing of optical fibers (i.e., welding the fibers together) for creating connections between optical fibers. Fusion splicing requires specialized equipment and highly skilled craftsman. Further, making moves, adds and/or changes among fusion spliced optical fibers in the optical network requires cutting the fibers and then fusing together the desired optical fibers, which is both time-consuming and expensive. In many applications it is desirable to make optical connections between optical fibers using fiber optic connectors that can be easily mated together and unmated, thereby making moves, adds and/or changes in the optical network much easier and faster for the craft.

However, making robust cable assemblies having optical connectors suitable for the rigors of the outdoor environment can be challenging. By way of example, the connectors must seal the optical connection from the elements along with handling wide temperature and humidity variations. Additionally, the craft may also employ certain installation procedures that can cause stress and/or strains on the cable assembly. For instance, typically outdoor installations coil slack loops to accommodate excess length of cable. These slack loops can couple the optical fibers in the cable to inhibit movement of the fibers in the cable which is desirable, but they also cause optical fiber movement and/or strain on the optical fibers within the cable. Typically, cables with loose fibers are manufactured with relatively small amounts of excess fiber length (EFL) and/or excess ribbon length (ERL) compared with the length of the cable (i.e., an overlength) so that the optical fibers are not strained when subjected to tensile forces on the cable assembly. However, these EFLs or ERLs can vary among the optical fibers or optical fiber ribbons within a fiber optic cable. Consequently, there is an unresolved need for robust cable assemblies for outdoor and/or indoor use.

### SUMMARY

The disclosure is directed to cable assemblies and methods for making the same. In one embodiment the cable assembly includes a fiber optic cable having at least one optical fiber disposed within a longitudinal passageway of the fiber optic cable and a first end of the cable. A connector is attached to the first end of the fiber optic cable and the at least one optical fiber is inhibited from movement adjacent to the first end of the fiber optic cable by a filling material disposed in the passageway of the fiber optic cable near the first end of the fiber optic cable. The filling material may be disposed within 75 millimeters of the first end of the fiber optic cable or may be disposed at the first end of the fiber optic cable.

In another embodiment, a cable assembly includes a fiber optic cable having a plurality of optical fibers disposed within a longitudinal passageway of the fiber optic cable and a first end. A connector is attached to the first end of the fiber optic cable and the at least one optical fiber is inhibited from movement adjacent to the first end of the fiber optic cable by a filling material disposed in the passageway of the fiber optic cable at the first end of the fiber optic cable so that the plurality of optical fibers have essentially the same length from the first end of the fiber optic cable to a ferrule of the connector. In other variations of cable assemblies, the plurality of optical fibers being aligned within the connector using a fiber tray.

The disclosure is also directed to a method of making a cable assembly including the steps of: providing a fiber optic cable having at least one optical fiber disposed within a longitudinal passageway of the fiber optic cable and a first end; inserting a filling material in the passageway of the fiber optic cable near the first end of the fiber optic cable; and installing a fiber optic connector on the first end of the fiber optic cable. Other optional steps include injecting the filling material into the passageway at the first end of the fiber optic cable or forming a window in the fiber optic cable near the first end and inserting the filling material into the window. Also the method may include a plurality of optical fibers having essentially the same length from the first end of the fiber optic cable to a ferrule of the connector.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is perspective end view of a fiber optic cable being prepared for connectorization;

FIG. 2 is a cross-sectional view of a cable assembly that includes the fiber optic cable of FIG. 1;

FIG. 3 is a schematic representation of a cable assembly being constructed where a window is formed in the fiber optic cable near an end of the cable;

FIG. 4 depicts a schematic representation of the cable assembly of FIG. 3 after injecting a filling material into the window in the fiber optical cable;

FIG. 5 depicts a schematic representation of the cable assembly of FIG. 4 having an optional sleeve for further sealing about the window in the fiber optic cable;

FIG. 6 depicts end views of hardened cable assemblies, specifically the fiber optic plug of FIG. 2 and a complimentary fiber optic receptacle for the fiber optic plug that are suitable for mating together and use the concepts disclosed herein;

FIG. 7 depicts a perspective view of a cable assemblies having a furcation body and a plurality of legs furcated and extending from the same; and

FIG. 8 is a top view of optical fibers of a fiber optic cable disposed in a fiber tray; and

FIG. 9 depicts a cross-sectional view of the fiber tray.

### DETAILED DESCRIPTION

Reference will now be made in detail to the embodiments of the disclosure, examples of which are illustrated in the accompanying drawings. Whenever possible, like reference numbers will be used to refer to like components or parts.

The cable assemblies described herein are suitable for making optical and/or electrical connections for a variety of devices. The concepts of the disclosure advantageously allow the simple, quick, and economical cable assemblies that provide a robust assembly for the craft. Specifically, the cable assemblies have a connector attached to an end of a cable so that at least one optical fiber of the cable is inhibited from movement inside the connector (i.e., applying pulling forces on the back of the connector) using a filling material disposed in the passageway of the cable near the end. In other words, the filling material restricts the movement of the optical fiber(s) between the cable and the connector of the cable assembly.

Reference will now be made in detail to the embodiments, examples of which are illustrated in the accompanying drawings. Whenever possible, like reference numbers will be used to refer to like components or parts.

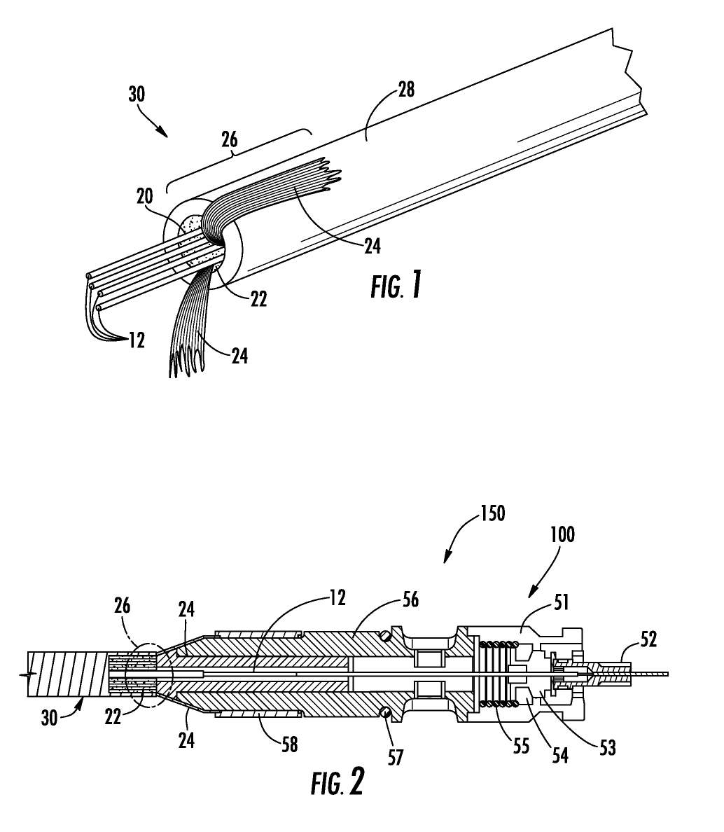

FIG. 1 is perspective end view of a fiber optic cable 30 being prepared for connectorization and FIG. 2 is a cross-sectional view of an explanatory cable assembly 150 having a connector 100 attached to a first end 26 of cable 30. As used herein, connector means any device that terminates at least one optical fiber for optical interconnection such as a plug, a receptacle, a jack or the like. Cable 30 includes at least one optical fiber 12 disposed within a longitudinal passageway 20 of the cable 30 and a first end 26. Connector 100 is attached to the first end 26 of cable 30, wherein the at least one optical fiber 12 is inhibited from movement adjacent to the first end of the fiber optic cable by a filling material 22 disposed in the passageway 20 of the cable 30 near the first end 26 of the cable. Consequently, the optical fibers exiting the cable 30 and attached to the connector have a length that stable within the connector. Stated another way, the optical fibers are inhibited from pistoning into and out of the cable so that forces that may pull optical fibers from the connector are reduced.

Explanatory cable 30 of FIG. 1 includes a plurality of optical fibers 12 within the passageway 20 of cable 30 that is defined by a cable jacket 28. In other cable configurations, the passageway may be defined by other structures such as a buffer tube or the like. Passageway 20 of cable 30 can also include other optional cable components therein such as strength members 24, ripcords, electrical conductors, water-blocking materials and the like as desired. As shown the first end 26 of cable 30 is prepared for attaching the connector to the optical fibers. Specifically, a portion of cable jacket 28 has been removed so that a portion of the optical fibers 12 are exposed. The strength members 24 may be moved out of way as shown and temporarily taped out of the way if desired. Then, a suitable filling material 22 can be inserted into passageway 20 of cable 30 near the first end 26, thereby inhibiting movement of the optical fiber(s).

Filling material 22 may be any suitable material such as an insert or injected material that is applied in the passageway of the cable. By way of example, filling material may be a foam plug that is pushed in or it may be a material such as a silicone or adhesive such as a liquid flowable RTV that is inserted by injecting the same into passageway of the cable. Depending on the type of filling material used curing may or may not be necessary. Of course, other suitable material as possible for functioning as the filling material. Other methods of inserting the filling material are possible for inhibiting movement of the optical fiber(s) between the cable and the connector. The optical fibers 12 of the fiber optic cable may be a plurality of optical fibers loosely disposed within the passageway of the cable, they may be ribbonized or have other suitable arrangements.

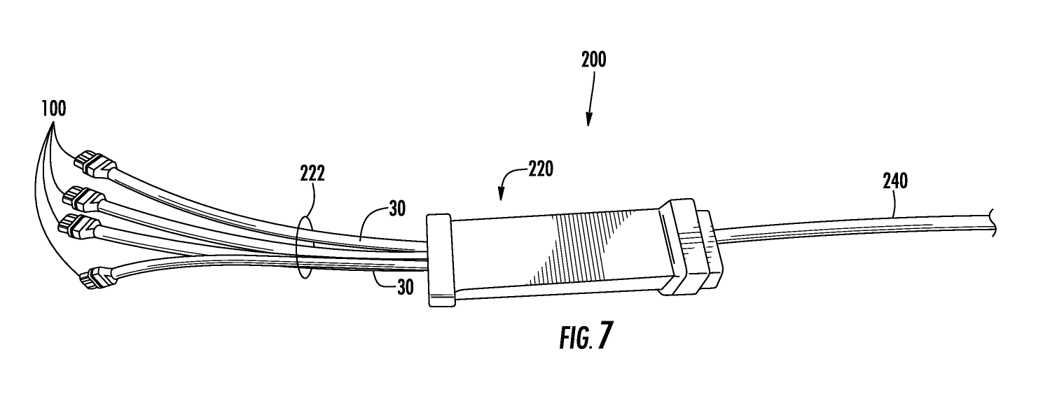

FIG. 2 is a cross-sectional view of cable assembly 150 depicting the optical fibers 12 near the first end 26 of cable 30 using filling material 22. As shown, connector 50 is a multi-fiber connector, but the connector may be a single-fiber connector. Specifically, the multi-fiber connector 50 shown is a hardened connector meaning that it is a rugged connector suitable for indoor/outdoor environments. Connector 50 includes an inner housing 51 that is secured to body 56, thereby securing ferrule 52, ferrule boot 53, spring centering cuff 54 and spring 55 therebetween. Connector 50 also includes an O-ring 57 that fits within a groove on body 56 and a crimp band 58 for securing the strength members 54 of cable 30 to connector 50. As depicted in FIG. 2, connector 50 is partially assembled since an outer housing 59, coupling nut 60, and alignment sleeve 63 are not shown on installed on the connector, but are shown installed onto the assembly in FIG. 6. Further details of connector 50 are described in U.S. Pat. No. 7,654,747, the contents of which are incorporated by reference herein.

The filling material 22 inhibits (i.e., restricts) movement of the optical fiber(s) between the cable and the connector. Stated another way, filling material 22 inhibits the optical fibers 12 from pistoning into the connector 100 from the fiber optic cable 30 at the point of application such as when the cable 30 is bent or coiled. Consequently, cable assembly 150 includes a plurality of optical fibers 12 having essentially the same length from the first end of the fiber optic cable to a ferrule of the connector. Moreover, the filling material 22 inhibits pulling forces on the optical fibers 12 from being transmitted to (i.e., reaching) the optical fibers where they are secured to the ferrule. In other words, the filling material 22 inhibits forces from pulling the optical fibers 12 from the back end of the ferrule.

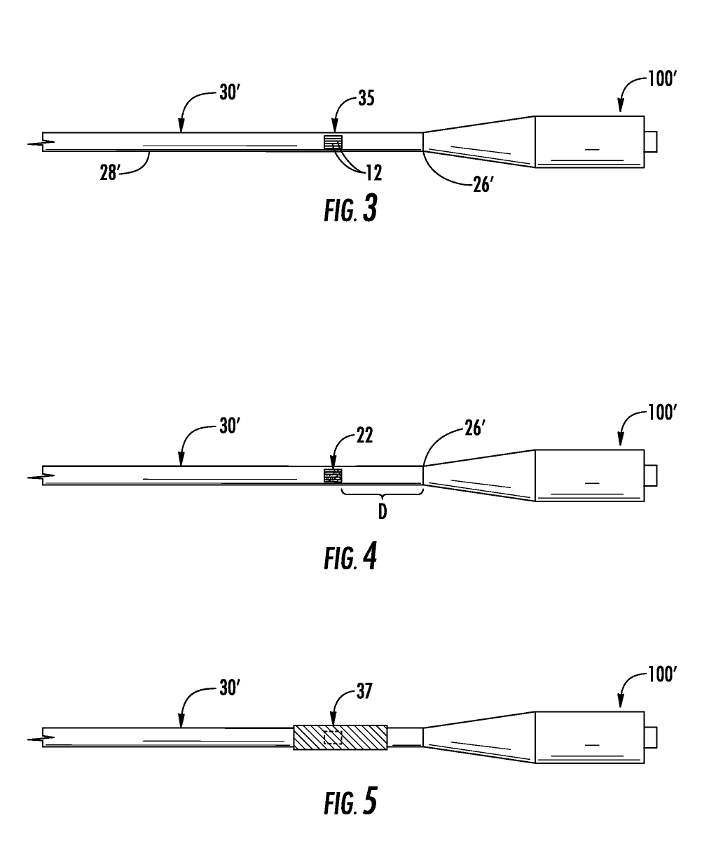

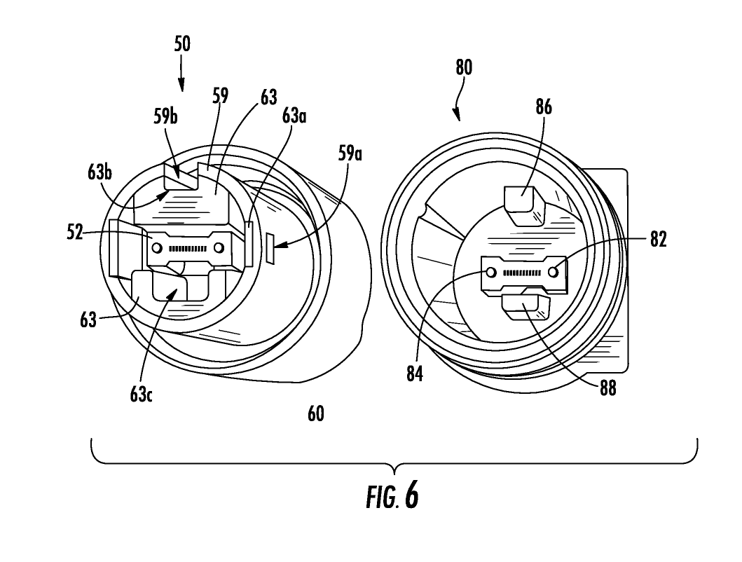

FIGS. 3-5 are schematic representations of a cable assembly having a filling material disposed in the passageway of the cable near the first end of the cable using an alternative method of construction. Specifically, FIG. 3 depicts a fiber optic cable 30′ having optical fibers 12 disposed within a longitudinal passageway of the same. A window 35 (i.e. opening) is formed in the cable jacket 28′ of fiber optic cable 30′ near the end of the cable. The window 35 is formed so that an opening to optical fibers 12 is present in cable 30′. The window 35 may be formed in the cable at any suitable time during the assembly process such as before the connector is attached or after the connector is attached. Window 35 is as small as possible for injecting filling material 22 about optical fibers 12 for inhibiting movement of the same. After a suitable window 35 is formed in fiber optic cable 30′, the filling material may be injected or is inserted through the window 35 and into the passageway of the cable as shown in FIG. 4.

Window 35 is formed near a first end 26′ of fiber optic cable 30′ within a distance D. Consequently, there is a relatively short distance of optical fiber 12 between the filling material and the ferrule of connector 100′. By way of example, the filling material 22 is disposed within 75 millimeters of the first end 26′ of fiber optic cable 30′; however, other suitable distances D are possible between the filling material 22 and the first end 26′ of the cable. Filling material 22 may also provide the function of sealing the window 35 if a suitable material is used. However, if desired a sleeve 37 may be optionally applied about window 35 for environmentally sealing the fiber optic cable 30′. FIG. 5 depicts a sleeve 37 such as a heat shrink sleeve applied about window 35 for providing additional environmental protection about the window 35.

FIG. 6 depicts end views of hardened connectors that are portions of cable assemblies that use the filling material for inhibiting the movement of optical fibers within the connectors of the respective assemblies. Specifically, FIG. 6 shows a completed connector 50 that is a fiber optic plug and a complimentary fiber optic receptacle 80 for mating with the fiber optic plug 50. More specifically, connector 50 includes outer housing 59, coupling nut 60 and alignment sleeve 63, thereby completing connector 50 so that it may be threadly engaged with receptacle 80. As shown, alignment sleeve 63 includes receiving features 63a that engage openings 59a of outer housing 59 for securing the alignment sleeve 63 to the outer housing 59. Outer housing 59 also includes a key slot 59b that is positioned to align with a key slot 63b of alignment sleeve 63. Additionally, alignment sleeve 63 also includes an opening 63c (i.e., pocket). The respective key slots 59b,63b and opening 63c are included so that connector 50 can only a mate with a complimentary receptacle that has the correct mating features. By way of example, receptacle 80 includes a ferrule 82 having alignment pins 84 for creating a pinned ferrule. The alignment pins 84 of ferrule 82 are received in bores (not numbered) of ferrule 52 in connector 50. However, before the respective ferrules can mate together, a key 86 and protruding feature 88 (i.e., excluding feature) of receptacle 80 must align with the respective key slots 59b,63b and opening 63c of connector 50. Consequently, the craft is inhibited from inadvertently damaging connector 50 or receptacle 80 if trying to mate non-conforming connectors with the same. Although, these embodiments are hardened connectors the concepts disclose herein may be used with other types of connectors and/or other types of cable assemblies.

By way of example, cable assemblies can be a portion of a larger cable assembly such as a furcated cable assembly. Illustratively, FIG. 7 depicts an explanatory cable assembly 200 that includes a furcation body 220 having a plurality of legs 222 that are formed from respective fiber optic cables 30 that form subunits of a larger fiber optic cable 240. As shown, fiber optic cables 30 each have a respective connector 100 on the end that includes filling material 22 disposed within the passageway of cable 30 near the end of the same. In other words, FIG. 7 depicts cable assembly 200 having a furcation body 220 with a plurality of sub-units 222 extending from one end thereof. As shown, furcation body 222 has fiber optic cable 240 entering the right end and a plurality of sub-units 222 exiting the left end. Inside the furcation body 220 the cable jacket of cable 240 is removed to expose the sub-units 222 formed by fiber optic cable 30 along with any strength members of cable 240 that are external of fiber optic cables 30. The sub-units 222 pass through the furcation body 220 and are terminated with a plurality of multi-fiber connectors 100, respectively. Any strength members of cable 240 may be strain relieved inside the furcation body 222 and the individual furcated legs (i.e., the sub-units 222) may include strength members within jacket 28 for providing strain relieve within each furcated leg by being attached to connector 100 as discussed above. Of course, the concepts disclosed herein may be used with other cable assemblies having plurality of sub-units. Likewise, the connector attached to the first end of the cable may be a multi-fiber connector or a single-fiber connector as desired. Simply stated, the concepts disclosed herein may be used with any suitable fiber optic cable, connector and/or components.

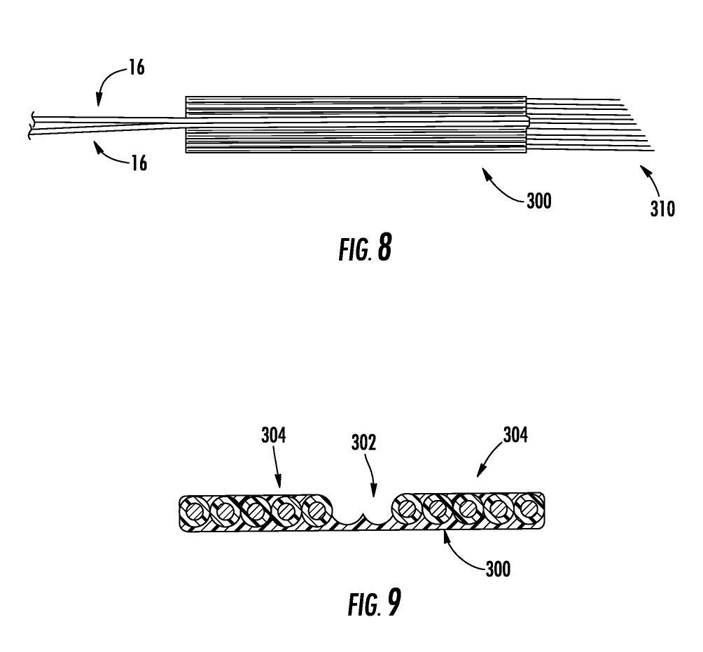

Additionally, the cable assemblies disclosed can include other features and/or structures as desired. For instance, the craft may desire to ribbonize the ends of loose optical fibers over a short length for correct alignment and easy insertion into the rear end of a ferule of the multi-fiber connector as well-known in the art. As one example, the craft may align the loose fibers in the desired sequence and then apply a tape or adhesive over a short length of the optical fibers to hold the same for insertion into the rear end of the ferrule. In other embodiments, the fiber optic cable including a plurality of optical fibers loosely disposed within the passageway may be aligned within the connector using a fiber tray 300 as shown in FIGS. 8 and 9. The fiber tray 300 is useful for cable assemblies when the ferrule of the connector has more ports (i.e., fiber bores) than active transmission optical fibers 12 in the cable (i.e., optical fibers for transmission of signals). Simply stated, the optical fibers 12 of the cable must be aligned into the proper bores of the ferrule of the connector, which can be difficult due to the very small structure of the bores in the ferrule. By way of explanatory example, the cable may have two optical fibers 12 and the ferrule of the connector has twelve bores for receiving optical fibers and the fibers must be aligned to the desired bores for optical transmission. Consequently, fiber tray 300 can aid in proper positioning of the two optical fibers relative to the twelve bores of the ferrule.

As shown in FIG. 8, the ends of two optical fibers 12 of the cable are placed into channels 302 of ribbon tray 300 for aligning optical fibers 12 in the center positions (e.g., positions 6 and 7, but any of the positions are possible) of a twelve position array. Although, the example shows two optical fibers 12, other embodiment can have any suitable number of optical fibers 12. Thereafter, a binding agent such as a tape, adhesive such as a glue stick or the like can be applied thereover if desired to maintain the position of the optical fibers 12 in the fiber tray 300. Further, the array of twelve fibers (i.e., the two optical fibers 12 of the cable and non-transmitting fibers of the ten fiber tray) can optionally have an angled cut 310 as shown for easily beginning the insertion process of the fiber array into the bores of the ferrule. Thus, the craft can easily insert optical fibers into the desired center bores of the ferrule (i.e., positions 6 and 7) of the connector. FIG. 9 shows a cross-sectional view of fiber tray 300 with non-transmitting outboard fibers or spacers 304 therein with channels 302 therebetween. Of course, the non-transmitting fibers can be arranged in a far-left or far-right arrangement leaving the channels 302 on respective sides of the fiber tray as desired. Fiber tray 300 can be formed from a piece of optical fiber ribbon having a top portion of the matrix stripped off and then removing the desired fiber from the same, thereby forming channels 302 and then cutting to the desired length.

The concepts disclosed herein may be used with any suitable connector and/or any suitable connector component. Methods for making the cable assembly are also disclosed. For instance, methods for making a cable assembly including the steps of providing a fiber optic cable having at least one optical fiber disposed within a longitudinal passageway of the fiber optic cable and a first end, inserting a filling material in the passageway of the fiber optic cable near the first end of the fiber optic cable, and installing a fiber optic connector on the first end of the fiber optic cable.

In one embodiment, the step of inserting the filling material into the passageway is accomplished by injecting the filling material into the passageway at the first end of the fiber optic cable such as depicted in FIG. 1. However, another suitable method of inserting the filling material includes the step of forming a window in the fiber optic cable near the first end of the cable and inserting the filling material into the window such as depicted in FIGS. 3 and 4. The method can also include the step of curing the filling material such as a heat, air or UV cure. The methods disclosed may also include the step of sealing the window. Sealing the window can be accomplished by simply using a suitable filling material that also functions to seal the window and/or it may include another component such as a sleeve for sealing the window. Whatever method is used the seal should be robust so that the window is sealed from environmental affect that may affect performance.

The method selected for creating the cable assembly produces a fiber optic cable where the plurality of optical fibers having essentially the same length from the first end of the fiber optic cable to a ferrule of the connector. As discussed above, the step of aligning the plurality of optical fibers of the cable within the connector may use a fiber tray as discussed in relation to FIGS. 8 and 9. Likewise, the method can include further include the step of furcating the fiber optic cable into a plurality of legs such as depicted in FIG. 7. Moreover, the step of installing a fiber optic connector onto the cable may include installing a hardened fiber optic connector.

Although the disclosure has been illustrated and described herein with reference to embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made without departing from the spirit and scope of the same. Thus, it is intended that the present application cover the modifications and variations provided they come within the scope of the appended claims and their equivalents.

We claim:

1. A cable assembly, comprising:
a fiber optic cable having at least one optical fiber disposed within a longitudinal passageway of the fiber optic cable and a first end; and
a connector attached to the first end of the fiber optic cable, wherein the at least one optical fiber is inhibited from movement adjacent to the first end of the fiber optic cable by a filling material disposed in the passageway of the fiber optic cable near the first end of the fiber optic cable.

2. The cable assembly of claim 1, the filling material being disposed within 75 millimeters of the first end of the fiber optic cable.

3. The cable assembly of claim 1, the filling material being disposed at the first end of the fiber optic cable.

4. The cable assembly of claim 1, the fiber optic cable including a plurality of optical fibers, the plurality of optical fibers having essentially the same length from the first end of the fiber optic cable to a ferrule of the connector.

5. The cable assembly of claim 1, the filling material being selected from a silicone, an adhesive or a plug.

6. The cable assembly of claim 1, the filling material inhibiting pistoning of the at least one optical fiber into the connector.

7. The cable assembly of claim 1, the fiber optic cable including a plurality of optical fibers loosely disposed within the passageway and being aligned within the connector using a fiber tray.

8. The cable assembly of claim 1, the connector being a hardened connector.

9. The cable assembly of claim 1, wherein the fiber optic cable includes a plurality of optical fibers loosely disposed within the passageway.

10. The cable assembly of claim 1, the connector being a multi-fiber connector.

11. The cable assembly of claim 1, further including a furcation body having a plurality of legs.

12. A cable assembly, comprising:
a fiber optic cable having a plurality of optical fibers disposed within a longitudinal passageway of the fiber optic cable and a first end; and
a connector attached to the first end of the fiber optic cable, wherein the at least one optical fiber is inhibited from movement adjacent to the first end of the fiber optic cable by a filling material disposed in the passageway of the fiber optic cable at the first end of the fiber optic cable, wherein the plurality of optical fibers have essentially the same length from the first end of the fiber optic cable to a ferrule of the connector.

13. The cable assembly of claim 12, wherein the plurality of optical fibers being aligned within the connector using a fiber tray.

14. A method of making a cable assembly, comprising the steps of:
providing a fiber optic cable having at least one optical fiber disposed within a longitudinal passageway of the fiber optic cable and a first end;
inserting a filling material in the passageway of the fiber optic cable near the first end of the fiber optic cable; and
installing a fiber optic connector on the first end of the fiber optic cable.

15. The method of claim 14, further including the step of injecting the filling material into the passageway at the first end of the fiber optic cable.

16. The method of claim 14, further including the step of forming a window in the fiber optic cable near the first end and inserting the filling material into the window.

17. The method of claim 16, further including the step of sealing the window.

18. The method of claim 14, the fiber optic cable including a plurality of optical fibers, the plurality of optical fibers having essentially the same length from the first end of the fiber optic cable to a ferrule of the connector.

19. The method of claim 14, further including the step of curing the filling material.

20. The method of claim 14, further including the step of aligning a plurality of optical fibers within the connector using a fiber tray.

21. The method of claim 14, further including the step of furcating the fiber optic cable.

22. The method of claim 14, the step of installing a fiber optic connector comprising installing a hardened fiber optic connector.
